(19) United States
(12) Patent Application Publication
(10) Pub. No.: US 2024/0376025 A1
(43) Pub. Date: Nov. 14, 2024

(54) PROCESS FOR DECHLORINATION OF WASTE PLASTICS

(71) Applicant: SABIC Global Technologies B.V., Bergen op Zoom (NL)

(72) Inventors: Robert C. Schucker, Spring, TX (US); Dustin Farmer, Houston, TX (US); Jason Loiland, Sugar Land, TX (US)

(21) Appl. No.: 18/683,198

(22) PCT Filed: Aug. 19, 2022
(86) PCT No.: PCT/EP2022/073214

§ 371 Date: Feb. 12, 2024

(30) Foreign Application Priority Data
Aug. 23, 2021 (EP) 21192586.2

(51) Int. Cl. C07C 1/30; B09B 3/40; B09B 3/70; B09B 101/77; B29B 17/00; B29B 17/02; B29K 27/06; C01B 7/03; C01D 3/04; C07C 7/00

(52) U.S. Cl. CPC C07C 1/30; B09B 3/40; B09B 3/70; B29B 17/02; C01B 7/035; C01D 3/04; C07C 7/00; B09B 2101/77; B29B 2017/001; B29B 2017/0203; B29B 2017/0224; B29K 2027/06

(57) ABSTRACT

A process involving the steps in this order of: providing a waste plastics stream (A) comprising polyvinyl chloride (PVC); (i) supplying the waste plastics stream (A) to a reactor vessel; (ii) subjecting the waste plastics in the reactor vessel to a temperature of ≥250° C. and ≤350° C., preferably of ≥275° C. and ≤325° C., preferably for a period of 5-30 minutes, under applying a vacuum, preferably of ≤35 mbar, or using an inert gas sweep, and evacuating the generated hydrogen chloride (B) from the vessel, wherein the PVC is partially dechlorinated to form a waste plastics stream (C) comprising partially unsaturated PVC; (iii) removing the waste plastics stream (C) comprising partially unsaturated PVC from the reaction vessel; and (iv) separating the partially unsaturated PVC from the waste plastics stream to form a dechlorinated waste plastics stream (D).

### CROSS-REFERENCE TO RELATED APPLICATIONS

This application is a National Stage application of PCT/EP2022/073214, filed Aug. 19, 2022, which claims the benefit of European Application No. 21192586.2, filed Aug. 23, 2021, both of which are incorporated by reference in their entireties herein.

### BACKGROUND

The present invention relates to a process for dechlorination of waste plastics.

One of the ubiquitously available sources of waste plastics is post-consumer waste streams. Such streams comprise collected plastics discarded by common household use. As in typical household use, the plastics that end up forming a waste are of very different origin and nature, and thereby of varying constitution, the stream of waste plastics collected from household use is typically a mixed waste plastic stream. It typically contains plastics of different types of chemical constitution, amongst which exemplary species include polyolefins such as polyethylenes and polypropylenes, polystyrenes, polyvinyl chlorides, and polyesters, to name only some. Furthermore, one may expect quite some batch-to-batch variation in composition of batches of collected post-consumer mixed plastics waste.

The mixed nature of such waste plastics streams, and the variations in batch-to-batch composition, pose certain challenges in terms of processability of the post-consumer mixed waste plastics. Many of the technologies that are available or being developed that target processing of mixed waste plastics into materials that can be re-used for purposes typical to plastic materials do provide certain product quality requirements for a batch of waste plastics to comply with in order to suitably serve as raw materials for conversion via such technologies.

One of the quality requirements is that the quantity of certain impurities must be below a certain level. A particular impurity whose presence in waste plastics is typically required to be low is chlorine atoms. During various processing steps of waste plastics, which may constitute either mechanical conversion steps or chemical conversion steps, chlorine atoms tend to detrimentally affect the processes and the equipment in which those processes are operated. A well-known issue associated with the presence of chlorine is corrosion of metals which are present in the operating equipment. Furthermore, when subjected to catalysed chemical conversion processes, the presence of chlorine may interfere with the catalytic activity of the used catalysts. Accordingly, most refinery and chemical operations have a limit to the amount of chlorine that can be contained in their feeds, for example, because one of the byproducts from downstream processing is hydrogen chloride (HCl), which is very corrosive and can cause severe damage to for example, metal parts, especially when water vapour is present.

In waste plastics streams, the chlorine atoms that may be present in it particularly originate from the presence of polyvinyl chloride plastics (PVC) in the waste plastic stream. PVC is a polymer product having many attractive properties, and is used ubiquitously and for a wide variety of applications. Accordingly, a waste plastics stream may comprise a certain quantity of chlorine atoms originating from PVC.

A particular route for processing waste plastics is by converting these plastics into chemical product streams that can again be used as building blocks to produce new chemical and/or polymer products of exactly the same quality as the products they originated from. This route is referred to as chemical recycling. Presently, typical processes that are used for conversion of mixed waste plastic products into chemical building blocks, or chemical feedstocks, involve a degradation of the plastics so that the polymer chains are broken into smaller molecular segments, in such way that the matter no longer retains its thermoplastic state, but is converted into oil-like, hydrocarbon products. Such products are typically referred to as pyrolysis oils. The degradation processes that are utilised typically are pyrolysis processes, wherein, particularly in the absence of oxygen, the waste plastics are subjected to a thermal or thermo-catalytic treatment that results in the breakdown of the polymer chains.

For the desired use as chemical feedstock materials, it is required that such pyrolysis oils are of a composition that renders them processable in the chemical unit operations that are commonly employed in the existing chemical and polymer process chains. Many chemical facilities, such as for example steam cracker facilities, have strict limitations regarding the specifications of the feed streams that can be processed, in order to safeguard the process continuity and efficiency, and the longevity of the facilities. The presence of chlorine atoms acts to the detriment of these requirements. As it is a driver at the present day to arrive at ways to enable utilisation of waste plastics-based feedstocks in existing chemical facilities, the ability to meet the feedstock specifications of these facilities is paramount.

### SUMMARY

It will therefore be understood that there is a desire for having available a process whereby the quantity of chlorine in waste plastics feeds is reduced. Such process would render waste plastics feeds more convenient to process in refinery and chemical facilities. This is now provided by the present invention by a process involving the steps in this order of:
(i) providing a waste plastics stream (A) comprising polyvinyl chloride (PVC);
(ii) supplying the waste plastics stream (A) to a reactor vessel;
(iii) subjecting the waste plastics in the reactor vessel to a temperature of ≥250° C. and ≤350° C., preferably of ≥275° C. and ≤325° C., preferably for a period of 5-30 minutes, under applying a vacuum, preferably of ≤35 mbar, or using an inert gas sweep, and evacuating the generated hydrogen chloride (B) from the vessel, wherein the PVC is partially dechlorinated to form a waste plastics stream (C) comprising partially unsaturated PVC;
(iv) removing the waste plastics stream (C) comprising partially unsaturated PVC from the reaction vessel; and
(v) separating the partially unsaturated PVC from the waste plastics stream to form a dechlorinated waste plastics stream (D).

### BRIEF DESCRIPTION OF THE DRAWINGS

For a more complete understanding, reference is now made to the following descriptions taken in conjunction with the accompanying drawings, in which:

FIG. 1 presents a representation of an embodiment of the process;

FIG. 2 presents a representation of an embodiment of the process; and

FIG. 3 presents a representation of an embodiment of the process.

### DETAILED DESCRIPTION

Such process allows for production of a dechlorinated waste plastics stream having a chlorine content of sufficiently low level to allow it to be processed in refinery and chemical processes. For example, such dechlorinated waste plastics stream may have a chlorine content of below 25 ppm.

The waste plastics stream (A) may for example comprise ≤10.0 wt % of PVC. For example, the waste plastics stream (A) may comprise ≥0.5 wt % and ≤10.0 wt % PVC, preferably ≥0.5 wt % and ≤5.0 wt %.

The waste plastics steam (A) that is supplied to the reactor vessel may be supplied to the reactor in a molten state. This may for example be achieved by passing the waste plastics stream via a melt extruder prior to supplying it to the reactor vessel. In such melt extruder, the waste plastics steam may be subjected to such temperature and shear profile to allow the mixture to melt, but preferably not too excessive to prevent cleavage of chlorine from carbon-chlorine bonds in the PVC. The occurrence of that reaction during the extruder processing stage could result in HCl gases that are to be evacuated via vent ports of the melt extruder. Due to the acidic nature thereof, this could cause corrosive effects to the extruder and thereby be detrimental to the longevity of the process. To avoid this, the conditions in the extruder are to be kept such that the extruder is operated at a temperature of ≤250° C., preferably of ≥180° C. and ≤225° C., so that the waste plastic will be converted to a molten state without cleavage of carbon-chlorine bonds occurring. It is preferred that the melt extruder is a single-screw melt extruder. This may contribute to avoiding excessive shear being introduced to the waste plastics. If excessive shear is applied, this may lead to occurrence of hot spots in the extruder where the conditions may be so that carbon-chlorine bond cleavage may occur.

Therefore, a preferred embodiment of the invention involves in the step (ii) passing the waste plastics stream (A) via a melt extruder, preferably a single-screw melt extruder, operating at a temperature of ≤250° C., preferably of ≥180° C. and ≤225° C., to obtain a molten waste plastics stream, and supplying the molten waste plastics stream to the reactor vessel.

In an alternative embodiment, the waste plastics stream (A) may be supplied to the reactor vessel as a slurry. In such embodiment, the waste plastics may be formed into a slurry using as medium a depolymerised oligomeric product (M), for example having an average molecular weight of between 5,000 and 25,000 g/mol, a hydrocarbon oil, such as a carbon black oil, or a vacuum gas oil, for example a heavy vacuum gas oil or a light vacuum gas oil. For example, the waste plastics stream may be supplied to the reactor vessel as a slurry comprising ≥5.0 and ≤90.0 wt % of the waste plastics and ≥10.0 and ≤95.0 wt % of a hydrocarbon oil medium, with regard to the total weight of the stream (A) that is supplied to the reactor vessel.

Preferably, the waste plastics are present in the reactor vessel in step (iii) in molten state or as a slurry.

For example, the waste plastics and the medium may be contacted under conditions wherein the waste plastics are in molten state. The molten waste plastics may be supplied at a temperature of between 200° C. and 325° C. This may be achieved by subjecting the waste plastics to a heater (5). The heater may for example be a hot oil heater. It is preferred that the medium is also supplied at a temperature of between 200° C. and 325° C. In a preferred embodiment, the molten waste plastics stream exiting the melt extruder is, prior to being supplied to the reactor vessel, further heated to a temperature of ≥250° C. and ≤325° C., preferably wherein the heating is performed using a hot oil system.

In the dechlorination reactor vessel, the conditions are such that the PVC that is present in the waste plastics is converted into HCl and a product, the partially unsaturated PVC, that is insoluble in the molten waste plastics stream. This partially unsaturated PVC may subsequently be separated from the mixed product stream that is obtained from the reactor vessel by a physical separation. The treatment in the reactor vessel may be performed in a continuous way or as a batch process. The reactor vessel may for example be a continuously stirred tank reactor (CSTR).

The reactor vessel may be equipped with an inert gas purge. As inert gas, nitrogen may be used.

The separation step (v) may for example be performed by passing the waste plastics

stream (C) comprising partially unsaturated PVC that is removed from the reaction vessel over a filter system in a state that the partially unsaturated PVC is present in the waste plastics stream in solid form, so that a dechlorinated waste plastics stream (D) and a solid partially unsaturated PVC stream (F) is obtained. Such filter system may for example be present in a separation system (2). It is preferred that the separation step (v) is performed at a temperature of ≥200° C., preferably of ≥200° C. and ≤300° C., more preferably of ≥250° C. and ≤300° C. At such temperatures, the unsaturated PVC is present in a solid form, whereas the remainder of waste plastics is present in molten form, which enables filtration separation of the unsaturated PVC. The filter system may for example have an average pore size of ≤25 μm. The separation may alternatively be performed by centrifugation.

To convey the waste plastics stream (C) to the separation system (2), a gear pump (8) may be positioned in the transport line transporting waste plastics stream (C) between the reactor vessel (1) and the separation system (2).

The dechlorinated waste plastics stream (D) that is obtained from the separation system (2) may be supplied to a pelletiser (10). In such pelletiser, the molten plastics that is now containing a chlorine content that is sufficiently low for use in chemical units is converted into pellets, and cooled to below melting temperatures, for example to a temperature of below 100° C. Such pellets may then be stored and further used in chemical decomposition processes to obtain for example chemicals for use as feedstocks for polymerisation processes, or may be used as plastic feedstocks in the manufacture of plastic products.

Alternatively, the dechlorinated waste plastics stream (D) that is obtained from the separation system (2) may be directly supplied to a depolymerisation reactor (11). In such depolymerisation reactor, the stream may be subject to a temperature of between 350 and 450° C., preferably of between 375 and 425° C. Such treatment may be performed in the depolymerisation reactor for a duration of between 15 and 90 minutes, preferably between 15 and 60 minutes, more preferably between 15 and 30 minutes. This treatment may be performed in a continuous way or as a batch process. The depolymerisation reactor may for example be a continuously stirred tank reactor (CSTR). The product that is obtained from the depolymerisation reactor may for example be a depolymerised oligomeric product (M), for example having an average molecular weight of between 5,000 and 25,000 g/mol. The oligomeric product may be cooled and converted into pellets. Alternatively, the oligomeric product (M) may be directly supplied to chemical or refinery conversion units. A fraction of the oligomeric product (M) may be fed back to the reactor vessel (1), for example to optimise dechlorination conditions in the reactor vessel.

The evacuated HCl stream (B) that is removed from the reaction vessel may for example be subjected to a caustic treatment to complex the HCl with NaOH, so as to obtain NaCl. Such caustic treatment may for example be performed using a caustic scrubber (7). The evacuated HCl stream (B) may be supplied to the caustic scrubber (7) by passing it via a steam ejector (9).

The evacuated HCl-containing stream (B) may in certain embodiments, immediately upon exiting the reactor vessel, be passed through a condenser to remove the medium, which subsequently may be returned into the reactor.

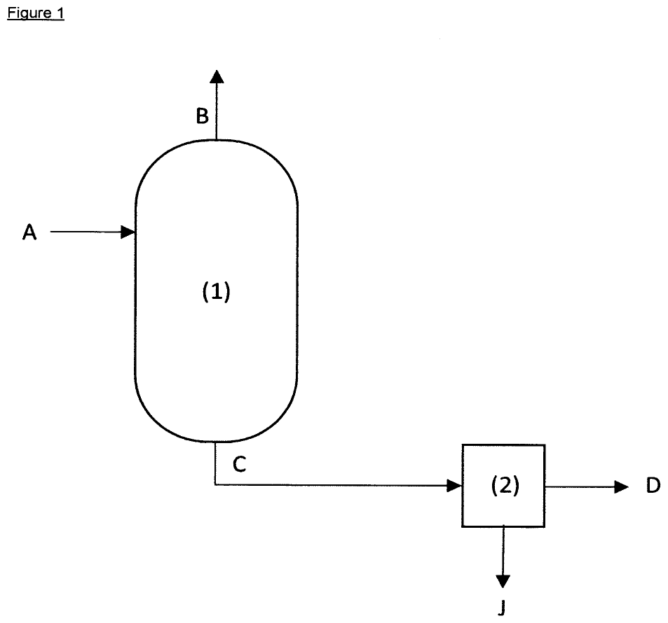

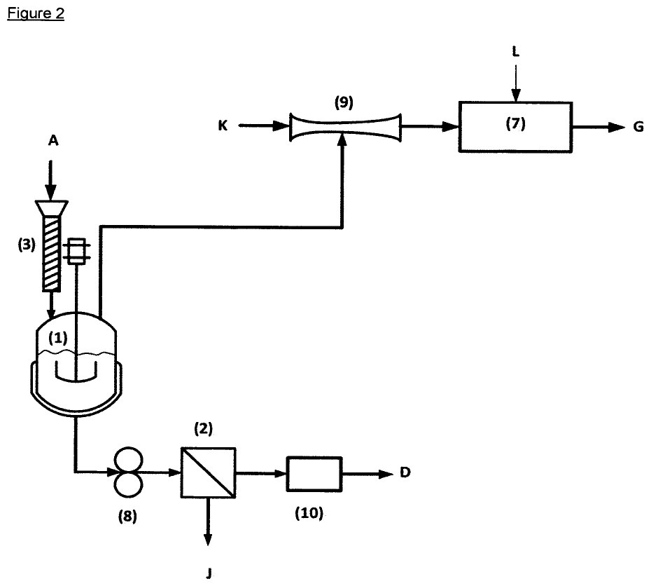

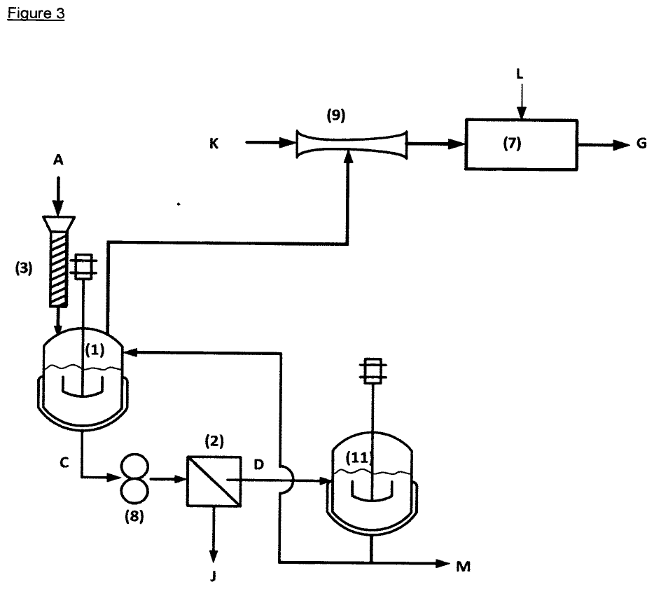

FIG. 1 presents a representation of an embodiment of the process according to the invention. FIGS. 2 and 3 each present a representation of the process of the invention including certain further embodiments of the process. In each of the Figures, where applicable, the numbers and letters represent:
(1) Reactor Vessel
(2) Separation System
(3) Melt Extruder
(5) Heater
(6) Condenser
(7) Caustic Scrubber
(8) Gear pump
(9) Steam Ejector
(10) Pelletiser
(11) Depolymerisation Reactor
A: Waste plastics stream
B: Hydrogen chloride
C: Waste plastics stream comprising partially unsaturated PVC
D: Dechlorinated waste plastics stream
E: Slurry Medium
F: Inert purge gas
G: Aqueous NaCl/NaOH
J: Partially unsaturated PVC
K: Steam
L: NaOH
M: Depolymerised oligomers

The invention will now be illustrated by the following non-limiting examples.

### Comparative Example 1

A mixture of 98.9 g high-density polyethylene (HDPE) having a weight-average molecular weight of 72,000 g/mol and 1.01 g polyvinyl chloride (PVC) having a weight-average molecular weight of 85,000 g/mol were added to a 250 cm³ stirred autoclave. The chlorine content of this mixture was 5,800 ppm by weight. The autoclave was closed and flushed three times with nitrogen to purge any oxygen from the system after which it was sealed. The temperature was raised to 450° C. at a rate of 10° C./min with stirring at 250 rpm and held for 30 minutes after which the reactor was cooled to room temperature.

As a result of chemical degradation of the polymer, gases were formed which caused a rise in pressure to 1580 kPa. After cooling, the reactor was vented and it was observed that the polymers had been fully converted to liquid products. Analysis of the liquid products by XRF showed a Cl content of 3,200 ppm by weight, indicating that HCl that was produced during the initial decomposition of PVC had recombined, at least in part, with reactive fragments of the HDPE/PVC mixture to form organochlorine compounds, which are undesirable in subsequent downstream refining and chemical processes which typically have a very low limit of chlorine content acceptable in their feeds.

### Comparative Example 2

A mixture of 98.6 g high-density polyethylene (HDPE) having a weight-average molecular weight of 72,000 g/mol and 1.01 g polyvinyl chloride (PVC) having a weight-average molecular weight of 85,000 g/mol were added to a 250 cm³ stirred autoclave. The chlorine content of this mixture was 5,800 ppm by weight. The autoclave was closed and flushed three times with nitrogen to purge any oxygen from the system after which it was sealed. The temperature was raised to 450° C. at a rate of 10° C./min with stirring at 250 rpm and held for 30 minutes after which the reactor was cooled to 325° C.

The reactor was subsequently vented and a stream of nitrogen at 150 cm³/min was introduced to sweep away vapour phase reaction products. After holding at 325° C. for 60 minutes, the reactor was cooled to room temperature. Analysis of the liquid products by XRF showed a Cl content of 838 ppm by weight, indicating that the recombination of HCl with reactive fragments of the HDPE/PVC mixture was to some degree reversible but the level of chlorine was still high.

### Example 1

A mixture of 99.0 g high-density polyethylene (HDPE) having a weight-average molecular weight of 72,000 g/mol and 1.0 g polyvinyl chloride (PVC) having a weight-average molecular weight of 85,000 g/mol were added to a 250 cm³ stirred autoclave. The chlorine content of this mixture was 5,800 ppm by weight. The autoclave was closed and flushed three times with nitrogen to purge any oxygen from the system after which a stream of nitrogen at 150 cm³/min was introduced. The temperature was raised to 325° C., which is below the temperature at which HDPE begins to decompose, and held for 60 minutes under continuous flow of nitrogen.

After 60 minutes, the nitrogen flow was stopped and the reactor was sealed. The temperature was then raised to 450° C. and held for 30 minutes, resulting in full conversion of the plastics to liquids, after which it was cooled to room temperature and vented. Analysis of the liquid product by XRF showed a chlorine content of 18 ppm by weight, indicating that the HCl generated at 325° C. according to the process of the present invention has been removed from the reactor via the nitrogen sweep leaving a liquid from which 99.7% of the chlorine that was originally present had been removed.

### Example 2

A mixture of 4.04 g high-density polyethylene (HDPE) having a weight-average molecular weight of 72,000 g/mol and 0.20 g polyvinyl chloride (PVC) having a weight-average molecular weight of 85,000 g/mol were added to a quartz boat of approximately 90 mm long by 20 mm wide and 15 mm deep. The chlorine content of this mixture was 29,000 ppm by weight. The boat containing the polymer mixture was placed in a 1.5″ (3.8 cm) tube furnace, and flushed with nitrogen to ensure that all oxygen was removed. After that, a flow of 150 cm³/min of nitrogen was established through the furnace. The furnace temperature was raised to 300° C. at a rate of 5° C./min and held at 300° C. for 60 minutes prior to cooling down to room temperature.

It was observed that the HDPE had melted and flowed to fill up the bottom of the boat, whereas the PVC had puffed up and turned black while essentially remaining in place. The ingot of solidified polymers that was formed upon cooling was removed from the quartz boat. The segment of the ingot containing the black PVC was broken off and supported on a piece of 16-mesh stainless steel screen which was placed atop the quartz boat. This was again placed in the tube furnace and the temperature was raised to 150° C., allowing the HDPE to melt and flow through the screen into the boat. After 60 minutes at 150° C., the furnace was cooled and the boat removed. It was observed that the HDPE had melted and fallen through the screen and collected in the bottom of the boat, whereas the black PVC was retained by the screen. The chlorine content of the collected HDPE was measured by XRF and found to be 30 ppm by weight, representing a reduction of 99.9% from the starting mixture.

From the above it can be observed that a process according to the present invention allows for a significant reduction of chlorine content in a mixed plastics stream. This is particularly desirable in processing of waste plastics streams, such as post-consumer mixed plastic waste streams. Such streams typically contain a fraction of chlorine-containing polymers, such as PVC, which is undesirable as presence of chlorine in plastics processing equipment can give rise to undesirable effects such as e.g. corrosion. By the process of the present invention, a solution to avoid this is provided.

1. Process for the dechlorination of waste plastics, the process involving the steps in this order of:
(i) providing a waste plastics stream (A) comprising polyvinyl chloride (PVC);
(ii) supplying the waste plastics stream (A) to a reactor vessel;
(iii) subjecting the waste plastics in the reactor vessel to a temperature of ≥250° C. to <350, under applying a vacuum or using an inert gas sweep, and evacuating the generated hydrogen chloride (B) from the vessel, wherein the PVC is partially dechlorinated to form a waste plastics stream (C) comprising partially unsaturated PVC; and
(iv) removing the waste plastics stream (C) comprising partially unsaturated PVC from the reaction vessel.

2. Process according to claim 1, wherein the waste plastics stream (A) comprises ≥0.5 and ≤10.0 wt % of PVC, with regard to the total weight of the waste plastics stream.

3. Process according to claim 1, wherein the waste plastics are present in the reactor vessel in step (iii) in a molten state or as a slurry.

4. Process according to claim 1, wherein the step (ii) involves passing the waste plastics stream (A) via a melt extruder operating at a temperature of ≤250° C. to obtain a molten waste plastics stream, and supplying the molten waste plastics stream to the reactor vessel.

5. Process according to claim 4, wherein the molten waste plastics stream exiting the melt extruder is, prior to being supplied to the reactor vessel, further heated to a temperature of ≥250° C. and ≤300° C.

6. Process according to claim 4, wherein the molten waste plastics stream is mixed with a medium (E), a hydrocarbon compound or composition that is suitable as feed for use in a subsequent refinery or chemical operation.

7. Process according to claim 1, wherein: the process further comprises (v) separating the partially unsaturated PVC from the waste plastics stream to form a dechlorinated waste plastics stream (D); and the separation step (v) is performed by passing the waste plastics stream (C) comprising partially unsaturated PVC that is removed from the reaction vessel over a filter system in a state that the partially unsaturated PVC is present in the waste plastics stream in solid form, so that the dechlorinated waste plastics stream (D) and a solid partially unsaturated PVC stream (F) is obtained.

8. Process according to claim 7, wherein the filter system has an average pore size of ≤25 μm.

9. Process according to claim 7, wherein: the process further comprises (v) separating the partially unsaturated PVC from the waste plastics stream to form a dechlorinated waste plastics stream (D); and the step (v) is performed at a temperature of ≥200° C.

10. Process according to claim 1, wherein the evacuated HCl stream (B) is subjected to a caustic treatment to complex HCl with NaOH to obtain NaCl.

11. Process according to claim 6, wherein the evacuated HCl-containing stream (B) is, immediately upon exiting the reactor vessel, passed through a condenser to remove medium, which subsequently is returned into the reactor.

12. Process according to claim 1, wherein the process is a continuously operating process.

13. Process according to claim 1, wherein the reactor vessel is equipped with an inert gas purge.
